(19) United States
(12) Patent Application Publication
(10) Pub. No.: US 2024/0391733 A1
(43) Pub. Date: Nov. 28, 2024

(54) SOLUTION FOR AN ELEVATOR CALL ALLOCATION OF AN ELEVATOR GROUP

(71) Applicant: KONE Corporation, Helsinki (FI)

(72) Inventors: Markus HARTIKAINEN, Helsinki (FI); Karthik SINDHYA, Helsinki (FI); Johan GRÖNHOLM, Helsinki (FI); Petteri VALJUS, Helsinki (FI); Tapio TYNI, Helsinki (FI)

(73) Assignee: KONE Corporation, Helsinki (FI)

(21) Appl. No.: 18/790,606

(22) Filed: Jul. 31, 2024

Related U.S. Application Data
(63) Continuation of application No. PCT/EP2022/055402, filed on Mar. 3, 2022.

(51) Int. Cl. B66B 1/34; B66B 7/12

(52) U.S. Cl. CPC B66B 1/34; B66B 7/1215; B66B 2201/23

(57) ABSTRACT

A method for an elevator call allocation of an elevator group includes obtaining call information indicative of at least one generated elevator call; generating a plurality of candidate allocations in response to obtaining the call information; defining at least two allocation objectives for each candidate allocation, wherein the defined at least two allocation objectives comprise a rope bending cost and at least one other allocation objective; and selecting the allocation for the at least one elevator call from among the candidate allocations based on the defined at least two allocation objectives. An elevator computing system and a computer program product for an elevator call allocation of an elevator group are also described.

### TECHNICAL FIELD

The invention concerns in general the technical field of elevators. Especially the invention concerns elevator call allocation in elevator groups.

### BACKGROUND

Typically, an elevator group may comprise a plurality of elevator cars arranged to travel along respective elevator shafts. The operations of the elevator group are controlled by an elevator group control unit. The operations of the elevator group may comprise e.g. allocation of elevator calls of the elevator group. The allocation is typically performed by the elevator group control unit. Typically, the elevator group control unit takes into account in the elevator call allocation at least one objective, such as waiting time, journey time, energy consumption, and/or power peaks. The elevator group control unit may use an optimization principle, such as multi-objective optimization in the elevator call allocation.

However, the elevator group control unit does not pay any attention for example to wear of elevator ropes in the elevator call allocation process. The source of wear on the elevator ropes is mainly bendings of the elevator ropes, which occur when the elevator car moves, and the elevator ropes bend around pulleys and a traction sheave. Wearing of the elevator ropes and their lifetime is proportional to the number elevator rope bendings around the traction sheave and pulleys. The more bendings of the elevator ropes occurs, the more the elevator ropes wear and the shorter the lifetime of the elevator ropes is.

When the elevator group operates normally, i.e. without taking the elevator rope wear into account in the allocation process, it may be possible that the bendings of the elevator ropes occur in an imbalanced way both within elevator ropes of a single elevator car and between elevator cars of the elevator group. This causes that the elevator ropes need to be changed even though parts of the elevator rope and/or elevator ropes of some elevator cars are still in good shape. In case of imbalanced elevator rope wear between elevator cars all elevator ropes shall be replaced at the same time because of requirements of standards. Moreover, a diameter and stiffness of the new elevator ropes are differentiating from old elevator ropes. Replacement of the elevator ropes is expensive and causes operation breaks and at least unnecessary site visits.

Thus, there is a need to further develop solutions for allocation of elevator calls of elevator groups.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, an elevator computing system, and a computer program for an elevator call allocation of an elevator group. Another objective of the invention is that the method, the elevator computing system, and the computer program for an elevator call allocation of an elevator group enable an optimized elevator call allocation while balancing elevator rope bendings, thereby increasing elevator rope lifetime.

The objectives of the invention are reached by a method, an elevator computing system, and a computer program as defined by the respective independent claims.

According to a first aspect, a method for an elevator call allocation of an elevator group is provided, wherein the method comprises: obtaining call information indicative of at least one generated elevator call; generating a plurality of candidate allocations in response to obtaining the call information; defining at least two allocation objectives for each candidate allocation, wherein the defined at least two allocation objectives comprise a rope bending cost and at least one other allocation objective; and selecting the allocation for the at least one elevator call from among the candidate allocations based on the defined at least two allocation objectives.

Each elevator rope of the elevator group may be divided into a plurality of rope segments, and wherein defining the rope bending cost for each candidate allocation may comprise: defining current condition data of each rope segment involved in said candidate allocation, defining condition change data of each rope segment involved in said candidate allocation, and defining the rope bending cost based on the defined current condition data and condition change data of each rope segment involved in said candidate allocation.

The defining the condition change data may comprise counting an estimation of bendings of each rope segment involved in said candidate allocation. The current condition data of each rope segment may comprise: a rope bending count of said rope segment indicating currently counted bendings of said rope segment, or a rope condition count of said rope segment indicating current condition of said rope segment defined by pre-estimated mapping between the rope condition count and the rope bending count of said rope segment.

Alternatively, the defining the condition change data may comprise providing an estimation of a changed condition of each rope segment involved in said candidate allocation by applying a rope condition model. The current condition data of each rope segment may comprise a modelled rope condition count of said rope segment defined by applying the rope condition model.

Alternatively, the current condition data of each segment may comprise a sensor-based rope condition count of said rope segment defined by using actual condition data representing the actual condition of said rope segment.

The actual condition data may be obtained by at least one rope condition monitoring sensor device arranged inside a respective elevator shaft of the elevator group and/or by a rope condition monitoring sensor device operated by a user during a maintenance visit.

The at least one rope condition monitoring sensor device may be a rope diameter monitoring device, and the rope condition count may comprise rope diameter data representing a diameter of the rope segment.

According to a second aspect, an elevator computing system for an elevator call allocation of an elevator group is provided, wherein the elevator computing system comprises: a processing unit comprising at least one processor; and a memory unit comprising at least one memory including computer program code; wherein the at least one memory and the computer program code are configured to, with the at least one processor, cause the elevator computing system to perform: obtain call information indicative of at least one generated elevator call; generate a plurality of candidate allocations in response to obtaining the call information; define at least two allocation objectives for each candidate allocation, wherein the defined at least two allocation objectives a rope bending cost and at least one other allocation objective; and select the allocation for the at least one elevator call from among the candidate allocations based on defined at least two allocation objectives.

Each elevator rope of the elevator group may be divided into a plurality of rope segments, and wherein the defining of the rope bending cost for each candidate allocation may comprise that the elevator computing system is configured to: define current condition data of each rope segment involved in said candidate allocation, define condition change data of each rope segment involved in said candidate allocation, and define the rope bending cost based on the defined current condition data and condition change data of each rope segment involved in said candidate allocation.

The defining of the condition change data may comprise that the elevator computing system is configured to count an estimation of bendings of each rope segment involved in said candidate allocation. The current condition data of each rope segment may comprise: a rope bending count of said rope segment indicating currently counted bendings of said rope segment, or a rope condition count of said rope segment indicating current condition of said rope segment defined by pre-estimated mapping between the rope condition count and the rope bending count of said rope segment.

Alternatively, the defining of the condition change data may comprise that the elevator computing system is configured to provide an estimation of a changed condition of each rope segment involved in said candidate allocation by applying a rope condition model. The current condition data of each rope segment may comprise a modelled rope condition count of said rope segment defined by applying the rope condition model.

Alternatively, the current condition data of each segment may comprise a sensor-based rope condition count of said rope segment defined by using actual condition data representing the actual condition of said rope segment.

The actual condition data may be obtained by at least one rope condition monitoring sensor device arranged inside a respective elevator shaft of the elevator group and/or by a rope condition monitoring sensor device operated by a user during a maintenance visit.

The at least one rope condition monitoring sensor device may be a rope diameter monitoring device, and the rope condition count may comprise rope diameter data representing a diameter of the rope segment.

According to a third aspect, a computer program product for an elevator call allocation of an elevator group is provided, which computer program product, when executed by at least one processor, cause an elevator computing system to perform the method as described above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1A illustrates schematically an example of an elevator system.

FIGS. 1B and 1C illustrate schematically examples of roping arrangements of suspension ropes.

FIG. 2A illustrates schematically an example of an elevator rope divided into four rope segments.

FIG. 2B illustrates schematically an example of a rope bending count of the rope segments of the example elevator rope of FIG. 2A.

FIG. 3A illustrates schematically an example of a definition of a modelled rope condition count by using a rope condition model.

FIGS. 3B and 3C illustrate schematically examples of updating a modelled rope condition count.

FIG. 4A illustrates schematically an example of a method for an elevator call allocation of an elevator group.

FIG. 4B illustrates schematically another example of a method for an elevator call allocation of an elevator group.

FIG. 5 illustrates schematically an example of a definition of modelled condition change data by using a rope condition model.

FIG. 6 illustrates schematically an example of components of an elevator group control unit.

FIG. 7 illustrates schematically an example of components of an external computing unit.

### DESCRIPTION OF THE EXEMPLIFYING EMBODIMENTS

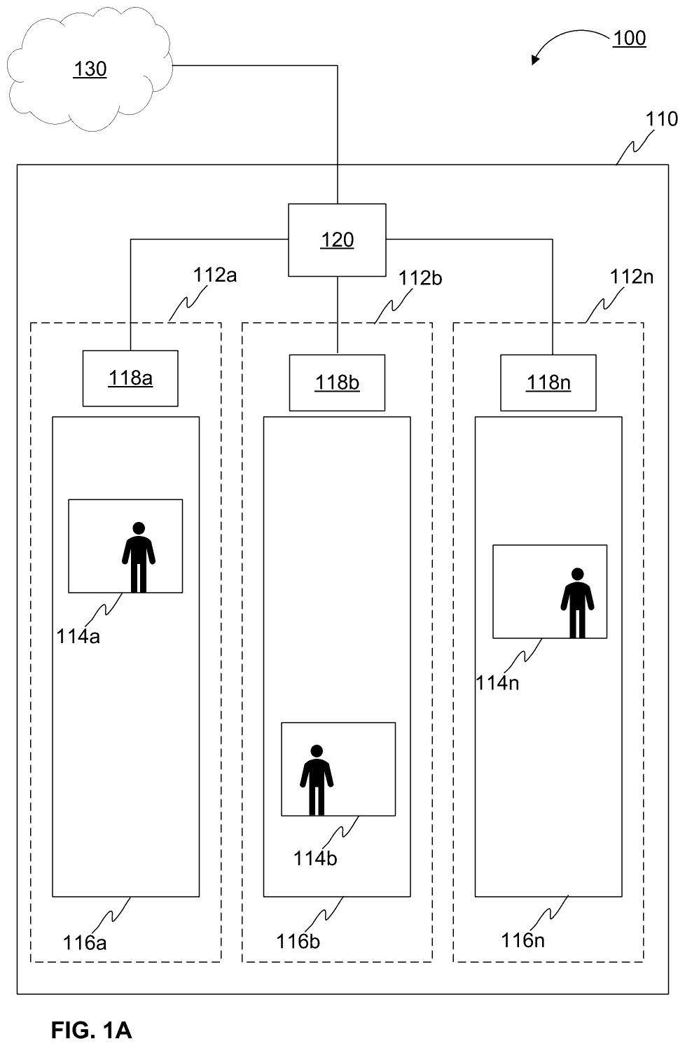

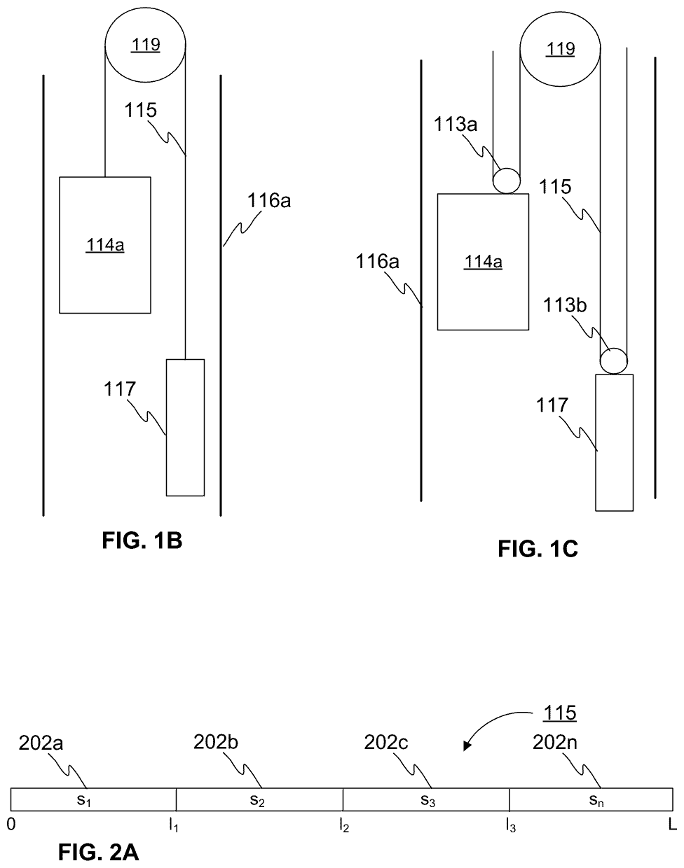

FIG. 1A illustrates schematically an example of an elevator system 100. The elevator system 100 comprises at least one elevator group 110. The elevator group 110 may comprise a plurality of elevators, i.e. a group of two or more elevators, 112a-112n. Each elevator 112a-112n may comprise at least one elevator car 114a-114n arranged to travel along an elevator shaft 116a-116n. In other words, the elevator group 110 comprises a plurality of elevator cars 114a-114n, each arranged to travel along a respective elevator shaft 116a-116n. In the example of FIG. 1A each elevator 112a-112n comprises one elevator car 114a-114n. The plurality of elevator cars 114a-114n of the elevator group 110 is configured to operate as a unit serving same landings. In the example of FIG. 1A the elevator system 100 comprises one elevator group 110, which comprises three elevators 112a-112n. The elevator group 110 further comprises an elevator group control unit 120 configured to control operations of the elevator group 110 at least in part. Each elevator 112a-112n of the elevator group 110 comprises an elevator control unit 118a-118n configured to control operations of the respective elevator 112a-112n at least in part. The elevator group control unit 120 may be communicatively coupled to the elevator control unit 118a-118n of each elevator 112a-112n. The communication between the elevator group control unit 120 and the elevator control unit 118a-118n of each elevator 112a-112n may be based on one or more known communication technologies, either wired or wireless. Each elevator 112a-112n may further comprise one or more known elevator related entities, e.g. elevator hoisting machinery, safety circuit and devices, an elevator door system, one or more user interface devices, etc., which are not shown in FIG. 1A for sake of clarity.

The elevator system 100 may further be associated with at least one external computing unit 130. The term “external” in the context of the computing unit means throughout this application a computing unit being external to the elevator system 110. The at least one external computing unit 130 may be located on-site and/or off-site. The at least one external computing unit 130 may comprise a server, a cloud server, remote monitoring server, computing circuit, and/or any other computing device or a network of computing devices being external to the elevator system 100. The elevator group control unit 120 may be communicatively coupled to the at least one external computing unit 130. The communication between the elevator group control unit 120 and the at least one external computing unit 130 may be based on one or more known communication technologies, either wired or wireless.

Each elevator 112a-112n of the elevator group 110 comprises elevator ropes 115, which are not shown in FIG. 1A for sake of clarity. The elevator ropes may comprise suspension ropes 115, i.e. hoisting ropes, compensating ropes, and governor ropes. The suspension ropes 115 are configured to carry, i.e. suspend, the elevator car 114a-114n so that the elevator car 114a-114n is in one end of the suspension ropes 115 and a counterweight 117 in the other end of the suspension ropes 115. The compensating ropes are configured to counterbalance, i.e. compensate, the weight of the suspension ropes. The compensating ropes run from the elevator car 114a-114n to the counterweight 117. The governor rope forms a continuous loop around a governor sheave and another weighted sheave at the bottom of the elevator shaft 116a-116n and is also attached to the elevator car 114a-114n and thus moves when the elevator car 114a-114n moves. A governor rope driven governor activates a safety gear when the elevator car 114a-114n moves at an overspeed. FIGS. 1B and 1C illustrate examples of roping arrangements of the suspension ropes 115. In the examples of 1B and 1C the example roping arrangements of the suspension ropes 115 of the elevator 112a of the elevator group 110 are shown from a side view, but similar example roping arrangements apply also to the suspension ropes of the other elevators 112b-112n of the elevator group 110. In FIG. 1B an example of a single wrap traction roping arrangement (i.e. a roping arrangement having a roping ration of 1:1) is illustrated, wherein one end of the suspension ropes 115 is arranged to the elevator car 114a, the other end of the suspension ropes 115 is arranged to the counterweight 117, and the suspension ropes 115 travel over once the traction sheave 119. In the example of FIG. 1C an example of a double wrap traction roping arrangement (i.e. a roping arrangement having a roping ration of 1:2) is illustrated, wherein the suspension ropes 115 are double wrapped around the traction sheave 119 and secondary sheaves 113a, 113b arranged to the elevator car 114a and the counterweight 117. In the examples of FIGS. 1B and 1C one suspension rope 115 is illustrated for sake of clarity, but also more than one parallel suspension ropes 115 may be used. The elevator ropes 115 wear during their lifetime. The source of wear on the elevator ropes 115 is mainly bendings of the elevator ropes 115, which occur when the elevator car 114a-114n travels along the shaft 116a-116n, and the elevator ropes 115 bend around pulleys, e.g. the secondary sheaves 113a, 113b, and the traction sheave 119. The wearing of the elevator ropes 115 and their lifetime is dependent on the number of bendings of the elevator ropes around the traction sheave and the secondary sheaves 113a, 113b. The more bendings of the elevator ropes 115 occurs, the more the elevator ropes 115 wear and the shorter the lifetime of the elevator ropes 115 is. Moreover, the number of bendings between different elevator ropes 115 of the elevator group 110 may be imbalanced. In other words, each elevator rope 115 of the elevator group 110 may have gathered different number of bendings than the other elevator ropes 115 of the elevator group 110. Similarly, the number of bendings within a single elevator rope 115 may be imbalanced. From now on the different embodiments are defined so that with the expression “elevator ropes” is preferably meant the suspension ropes 115. However, the embodiments may also be implemented with the compensating ropes and/or the governor ropes.

The elevator system 100 may further comprise rope condition monitoring sensor devices arranged inside the elevator shafts 116a-116n of the elevator group 110 and configured to provide actual condition data of the elevator ropes 115 or at least part of the elevator ropes 115 representing the actual condition of the elevator ropes 115 or the at least part of the elevator ropes 115. In other words, at least one rope condition monitoring sensor device may be arranged inside each elevator shaft 116a-116n of the elevator group 110 to obtain the condition data of the elevator ropes 115 residing inside the respective elevator shaft 116a-116n. The at least one rope condition monitoring sensor device may be arranged inside each elevator shaft 116a-116n so that it is capable to obtain the actual condition data of at least one elevator rope 115 residing inside said elevator shaft 116a-116n. For example, a rope condition monitoring sensor device may surround the elevator rope 115 to be monitored. The rope condition monitoring sensor device may for example be, but is not limited to, arranged, e.g. fixed, to the elevator hoisting machinery or a bedplate of the hoisting machinery. For sake of clarity the at least one rope condition monitoring sensor device is not shown in FIGS. 1A-1C. The rope condition monitoring sensor devices may be configured to provide the obtained actual condition data to the elevator group control unit 120 directly or via the respective elevator control unit 118a-118n. The elevator group control unit 120 may be configured to provide the obtained actual condition data to the external computing unit 130, if needed. The rope condition monitoring sensor devices may for example be rope diameter monitoring devices. In that case the actual condition data may comprise rope diameter data representing the actual diameter of the elevator ropes 115 or the at least part of the elevator roper 115.

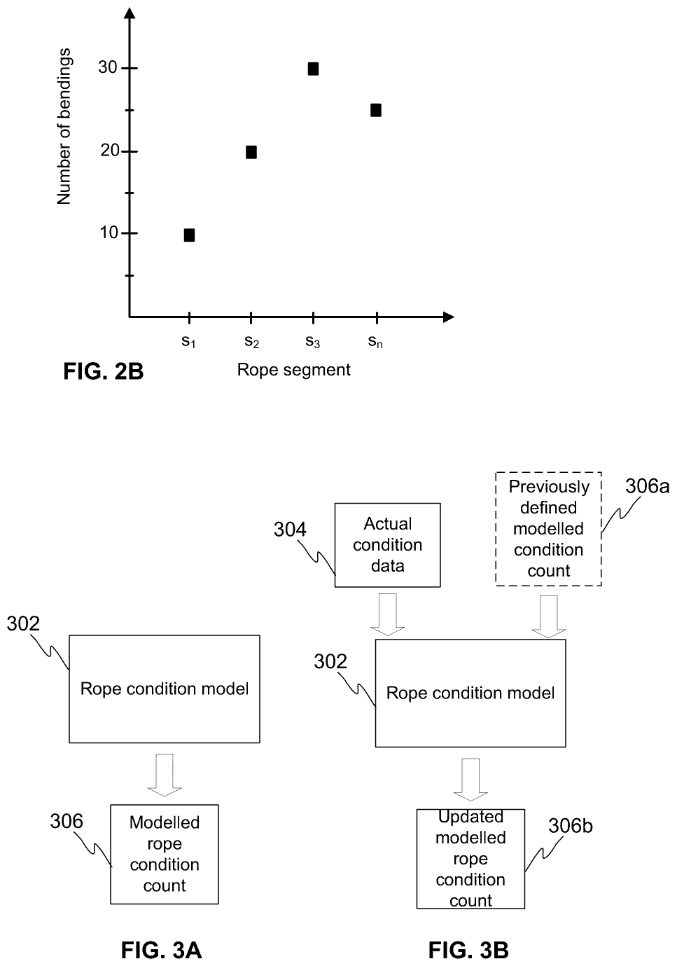

Rope bending counts, i.e. the number of occurred bendings, for each elevator rope 115 of the elevator group 110 may be counted and maintained by an elevator computing system comprising the elevator group control unit 120 and/or the external computing unit 130. This may be based on a discretized model of each elevator rope 115. In other words, each elevator rope 115 of the elevator group 110 may be divided in a length direction into a plurality of rope segments 202a-202n (s₁, s₂, s₃, . . . , sₙ). For example, the length of each elevator rope [0, L] may be discretized into N rope segments [0, I₁], [I₁, I₂], . . . , [I_{(N-1)}, L], where N is a finite number. For each rope segment 202a-202n of each elevator rope 115 the rope bending count may be counted and maintained. FIG. 2A illustrates an example of an elevator rope 115 divided into four rope segments (s₁, s₂, s₃, and sₙ) 202a-202n in the length direction of the elevator rope 115. Length of the first rope segment 202a is I₁, length of the second rope segment 202b is I₂−I₁, length of the third rope segment 202c is I₃−I₂, and length of the fourth rope segment is L−I₃. FIG. 2B illustrates schematically an example of a rope bending count of the rope segments 202a-202n of the example elevator rope 115 of FIG. 2A. 10 bendings have been counted to the first rope segment 202a (s₁), 20 bendings have been counted to the second rope segment 202b (s₂), 30 bendings have been counted to the third rope segment 202c (s₃), and 25 bendings have been counted to the fourth rope segment 202n (sₙ). FIG. 2B shows that the number of bendings may be unbalanced between the segments 202a-202n of the single example elevator rope 115. Above it is discussed that each elevator rope 115 may be divided into the plurality of rope segments 202a-202n. However, alternatively a travel of each elevator car 114a-114n along the respective elevator shaft 116a-116n may be discretized, i.e. segmented, by dividing the travel into a plurality of segments. As discussed above, the elevator rope 115 bends around the pulleys and the traction sheave 119, when the elevator car 114a-114n travels along the elevator shaft 116a-116n. Thus, the rope bending count may also be counted and maintained for each segment of the travel of each elevator car 114a-114n along the respective elevator shaft 116a-116n. Therefore, from now on with the term “rope segment(s)” is meant the (rope) segment(s) of the elevator rope 115 and also the (travel) segment(s) of the travel of the elevator car 114a-114n along the elevator shaft 116a-116n.

Next an example of counting of the rope bending counts of a single elevator rope, which belongs to the elevator ropes 115 of the elevator group 110, is discussed. The rope bending counts for each elevator rope 115 of the elevator group 110 may be counted similarly. The counting of the rope bending counts of the elevator rope 115 may comprise, every time the elevator car 114a-114n associated with the elevator rope 115 travels from a landing to another, i.e. a movement cycle of the elevator car 114a-114n occurs, determining the rope segments 202a-202n of the (discretized) elevator rope 115 that are bent based on movement data of the movement cycle of the elevator car 114a-114n and predefined layout data, and increasing the rope bending count, i.e. the number of bendings, of each bent rope segment 202a-202n by one. The movement data of the movement cycle of the elevator car 114a-114n may for example comprise a starting time (i.e. timestamp) of the movement of the elevator car 114a-114n, an elevator identifier (ID) identifying the elevator car 114a-114n, an origin landing, a destination landing, load data of the elevator car 114a-114n, and/or one or more other movement factors. The movement data of the movement cycle of each elevator car 114a-114n of the elevator group 110 may be obtained by the elevator group control unit 120 e.g. from the respective elevator control unit 118a-118n. The elevator group control unit 120 may further provide the movement data to the external computing unit 130. The external computing unit 130 may count and maintain the rope bending counts of the elevator ropes 115 of the elevator group 110 based on the movement data obtained from the elevator group control unit 120 as discussed above for the single elevator rope. Alternatively or in addition, the elevator group control unit 120 may count the rope bending counts of the elevator ropes 115 of the elevator group 110 as discussed above for the single elevator rope and further provide the rope bending counts of the elevator ropes 115 to the external computing unit 130. The rope bending counts of the elevator ropes 115 may be maintained by the elevator group control unit 120 and/or the external computing unit 130. The predefined layout data may comprise a layout of each elevator 112a-112n of the elevator group 110. The layout of each elevator 112a-112n may represent a mechanical roping configuration data of said elevator 112a-112n. The mechanical roping configuration data of each elevator 112a-112n may comprise for example location data of the traction sheave 119 and possibly also location data of the secondary sheaves 113a, 113b (if the secondary sheaves 113a, 113b are comprised in the roping arrangement) as a function of a location of the elevator car 114a-114n inside the elevator shaft 116a-116n, and/or dimeter data of the elevator rope 115. The location data of the traction sheave 119 as the function of the location of the elevator car 114a-114n inside the elevator shaft 116a-116n may represent the location of the traction sheave in relation to the elevator rope 115 as a function of a location of the elevator car 114a-114n inside the elevator shaft 116a-116n. Similarly, the location data of the secondary sheaves 113a, 113b as the function of the location of the elevator car 114a-114n inside the elevator shaft 116a-116n may represent the locations of the secondary sheaves 113a, 113b in relation to the elevator rope 115 as a function of a location of the elevator car 114a-114n inside the elevator shaft 116a-116n. Based on the predefined layout data and the movement data the elevator computing system 120, 130 may define the rope segment(s) 202a-202n that are bent around the traction sheave 119 and/or the secondary sheaves 113a, 113b due to each movement cycle of the elevator car 114a-114n in the above defined counting of the rope bending counts of the elevator rope 115.

Alternatively or in addition, the elevator computing system 120, 130 may define and maintain rope condition counts for each elevator rope 115 of the elevator group 110. Also, this may be based on the discretized model of each elevator rope 115. Similarly, as described above for the rope bending count, the rope condition count may be defined and maintained for each rope segment 202a-202n of each elevator rope 115 of the elevator group 110. For example, the rope condition count may be expressed in percentage values so that 100% means that the rope segment 202a-202n has a perfect condition and 0% means that the rope segment 202a-202n is broken. According to another example, the rope condition count may be expressed as rope diameter data representing a diameter of the rope segment 202a-202n. The rope condition count of a single rope segment 202a-202n defines numerically the condition of said single rope segment 202a-202n. The elevator computing system 120, 130 may use in the defining of the rope condition count a pre-estimated mapping between the rope condition count and the rope bending count. For example, if an elevator rope 115 is expected to last for 100000 bendings independent of the load of the elevator car 114a-114n, the rope condition count may be defined as a function of the bending count by the formula: (100000−bending count)/100000. Next an example of defining of the rope condition count of a single elevator rope, which belongs to the elevator ropes 115 of the elevator group 110, is discussed. The rope condition count for each elevator rope 115 of the elevator group 110 may be defined similarly. The defining of the rope condition count of the elevator rope 115 may comprise, every time the elevator car 114a-114n associated with the elevator rope 115 travels from a landing to another, i.e. the movement cycle of the elevator car 114-114n occurs, determining based on the movement data of the elevator car 114a-114n and the predefined layout data the rope segments 202a-202n of the elevator rope 115 that are bent, and increasing the number of bendings of each of the bent rope segments 202a-202n by one and defining the rope condition count according to the pre-estimated mapping between the rope condition count and the rope bending count. The elevator group control unit 120 may define the rope condition counts of the elevator ropes 115 of the elevator group 110 as discussed above for the single elevator rope. The elevator group control unit 120 may further provide the rope condition counts of the elevator ropes 115 to the external computing unit 130. The rope condition counts of the elevator ropes 115 may be maintained by the elevator group control unit 120 and/or the external computing unit 130. Alternatively or in addition, the external computing unit 130 may define and maintain the rope condition counts of the elevator ropes 115 of the elevator group 110 based on the movement data obtained from the elevator group control unit 120 as discussed above for the single elevator rope.

Above it is discussed that the source of wear on the elevator ropes 115 is mainly the bendings of the elevator ropes 115. However, the wear of the elevator ropes 115 may further depend on one or more other observable factors, e.g. a load of the elevator car 114a-114n and/or a speed profile of an elevator drive of the elevator car 114a-114n. For example, if the rope wear depends further on the load of the elevator car 114a-114n, the defined rope condition counts of the elevator ropes 115 may be adjusted depending on the load of the associated elevator car 114a-114n and/or the speed profile of the elevator drive of the elevator car 114a-114n.

Alternatively, the rope condition count of each rope segment 202a-202n of each elevator rope 115 may be defined by using the actual condition data of the respective rope segment 202a-202n representing the actual condition of the respective rope segment 202a-202n. The actual condition data of the rope segments 202a-202n may be obtained by the rope condition monitoring sensor devices arranged inside the elevator shafts 116a-116n and/or a rope condition monitoring sensor device operated by a user, e.g. a maintenance person, during a maintenance visit. A term “sensor-based rope condition count” is used throughout this application to mean the rope condition count defined by using the actual condition data of the rope segments 202a-202n obtained by the rope condition monitoring sensor devices arranged inside the elevator shafts 116a-116n and/or the rope condition monitoring sensor device operated by the user during the maintenance visit. The rope condition count may start to vary from the actual condition of the elevator rope 115 or the rope segment 202a-202n of the elevator rope 115 over the time for example due to assumptions made in the pre-estimated mapping between the rope condition count and the rope bending count and/or a spatial variation in the original condition of the elevator rope 115. The actual condition may also depend on elevator shaft conditions (e.g. moisture, temperature, etc.) and/or lubrication of the elevator rope 115. Thus, the using the sensor-based rope condition count enables to keep the rope condition count as similar to the actual condition of the elevator rope 115 as possible.

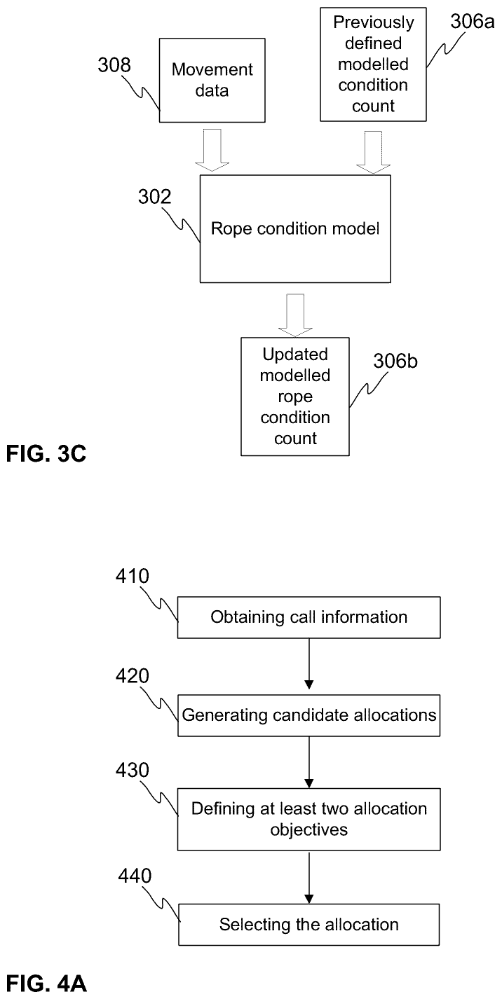

Alternatively, the elevator computing system 120, 130 may define the rope condition counts of each elevator rope 115 by applying a rope condition model 302. A term “modelled rope condition count” is used throughout this application to mean the rope condition count defined by using the rope condition model 302. Next the rope condition model 302 is discussed referring to FIG. 3A, which illustrates schematically a simple example of the definition of the modelled rope condition count 306 by using the rope condition model 302. The modelled rope condition count for each rope segment 202a-202n of each elevator rope 115 of the elevator group 110 may be defined by using the rope condition model 302. The rope condition model 302 may provide, i.e. generate, the modelled rope condition count 306 as its output data. In other words, the elevator computing system 120, 130 is able to infer or estimate by using the rope condition model 302 the modelled rope condition count representing a numerical estimation of the current condition of the rope segment 202a-202n, i.e. what is the currently estimated condition of the rope segment 202a-202n. According to an example, the predefined layout data may be used as pre-information for the rope condition model 302. For example, the rope condition model 302 may be a linear-Gaussian state-space model and the generated modelled rope condition count 306 may for example be a probability distribution, e.g. a multivariate Gaussian distribution. Instead of a piecewise discretization, the rope condition model 302 may alternatively apply a continuous Gaussian process e.g. by using a basis function approach. Alternatively, nonlinear versions (suitably linearized) may also be applied. The probabilistic state-space model approach is given only one example and any other models, e.g. machine learning models, such as splines model approach, may also be used as the rope condition model 302.

The elevator computing system 120, 130 may update the modelled rope condition counts 306 of the rope segments 202a-202n by using the actual condition data of the rope segments 202a-202n. This improves the accuracy of the modelled rope condition counts 306 of the rope segments 202a-202n. The actual condition data of the rope segments 202a-202n may be obtained by the rope condition monitoring sensor devices arranged inside the elevator shafts 116a-116n and/or the rope condition monitoring sensor device operated by the user during the maintenance visit. If the obtained actual condition data of the rope segments 202a-202n corresponds substantially to the actual condition of the respective rope segment 202a-202n, the updating the modelled rope condition count 306 of each rope segment 202a-202n may comprise replacing the previously defined modelled condition count 306a of each rope segment 202a-202n with the actual condition data of the respective rope segment 202a-202n. Alternatively, if the obtained actual condition data of the rope segments 202a-202n corresponds only partly to the actual condition of the respective rope segments 202a-202n, the updating the modelled rope condition count 306 of each rope segment 202a-202n may comprise using the previously defined modelled rope condition count 306a of each rope segment 202a-202n (i.e. the modelled rope condition count 306 before obtaining the actual condition data) and the actual condition data of the rope segments 202a-202n as input data for the rope condition model 302 to provide the updated modelled rope condition count 306b as the output of the rope condition model 302. An example of the updating the modelled rope condition count by using the actual condition data 304 is illustrated in FIG. 3B.

Alternatively or in addition, the elevator computing system 120, 130 may update the modelled rope condition counts 306 of the segments 202a-202n after each realized movement cycle by using the respective movement data 308 of the realized movement cycle. This enables that the modelled rope condition count 306 may be maintained up to date according to the realized movement cycles of the elevator cars 114a-114n, which in turn improves the accuracy of the modelled rope condition counts 306 of the rope segments 202a-202n. One realized movement cycle of one elevator car 114a-114n corresponds to a realized movement of the elevator car 114a-114n from a floor to another floor. The movement data of each realized movement cycle may comprise starting time (i.e. timestamp) of said realized movement cycle, an elevator identifier (ID) identifying the elevator car 114a-114n, an origin landing of said realized movement cycle, a destination landing of said realized movement cycle, a load data of the elevator car 114a-114n, and/or one or more other movement factors. The updating the modelled rope condition count 306 by using the movement data 308 of the realized movement cycle may comprise using the previously modelled rope condition count 306a (i.e. the modelled rope condition count before the realized movement cycle) and the movement data 308 of the realized movement cycle as inputs for the rope condition model 302 to provide the updated modelled rope condition count 306b as the output of the rope condition model 302. An example of the updating the modelled rope condition count by using the realized movement data 308 is illustrated in FIG. 3C.

Alternatively or in addition, the rope condition model 302 may be trained by using historical movement data of realized movement cycles and/or historical actual condition data. The historical movement data of the realized movement cycles and the historical actual condition data may be gathered in the long term during the operation of the elevator group 110. The elevator group control unit 120 may obtain the historical movement data of the realized movement cycles for example from the elevator control systems 118a-118n of the elevator group 110. The elevator group control unit 120 may provide the obtained historical movement data of the realized movement cycles to the external computing unit 130, if needed. The elevator group control unit 120 may obtain the historical actual condition data for example from the at least one rope condition monitoring sensor device directly or via the elevator control systems 118a-118n of the elevator group 110. The elevator group control unit 120 may provide the obtained historical actual condition data to the external computing unit 130, if needed. When the rope condition model 302 is trained properly, the accuracy of the generated output of the rope condition model 302, e.g. the modelled rope condition count 306, may be increased.

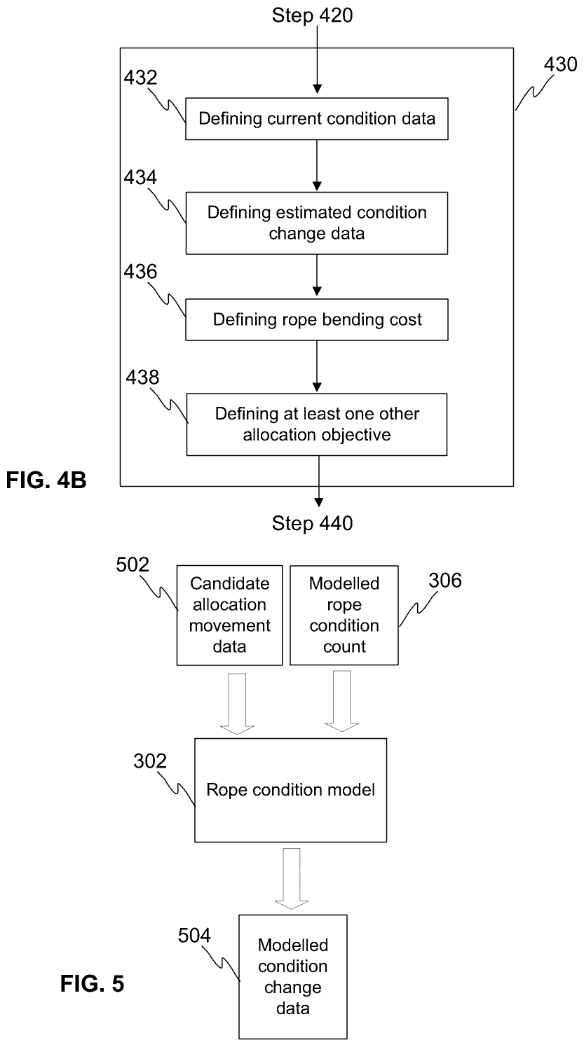

An example of a method for an elevator call allocation of an elevator group 110 is described by referring to FIG. 4A, which illustrates the method as a flow chart. In the method of FIG. 4A the wear of the elevator ropes 115 of the elevator group 110 may be taken into account in the allocation of the elevator calls of the elevator group 110. This enables that the number of rope bendings may be balanced between rope segments 202a-202n of a single elevator rope 115 and also between the elevator ropes 115 of the elevator group 110 and thereby enables increasing the lifetime of the elevator ropes 115. Preferably, in this example method the elevator ropes 115 of the elevator group 110 may comprise the suspension ropes, which means that the wear of the suspension ropes of the elevator group 110 may be taken into account in the allocation of the elevator calls of the elevator group 110. However, the elevator ropes 115 of the elevator group 110 may also comprise the compensating ropes and/or the governor ropes, which means that the wear of the compensating ropes and/or the governor ropes of the elevator group 110 may be taken into account in the allocation of the elevator calls of the elevator group 110. The method may be performed, i.e. executed, by the elevator computing system 120, 130. In other words, the method may be performed at least partially by the elevator group control unit 120 and/or at least partially by the external computing unit 130. This means that the elevator group control unit 120 may perform the method alone, the external computing unit 130 may perform the method alone, or the elevator group control unit 120 may perform the method at least partially together with the external computing unit 130.

At a step 410, the elevator computing system 120, 130 obtains call information indicative of at least one generated elevator call, i.e. at least one currently existing, i.e. open, elevator call. The call information may be obtained in response to receiving at least one new elevator call or in response to detecting a need to reallocate all open elevator calls. The at least one new elevator call may be generated in response to a user interaction, e.g. by pushing of an elevator user interface button by a user, via a user interface, e.g. a landing call panel, a car operating panel, a destination operating panel, or any other user interface device capable for generating the elevator calls. For sake of clarity the user interface is not shown in FIG. 1A. The call information may be provided to the elevator group control unit 120 from the user interface directly or via at least one of the elevator control systems 118a-118n. The elevator group control unit 120 may provide the call information to the external computing unit 130, if needed. The at least one elevator call may be an elevator car call, a landing call, and/or a destination call. The elevator car call may comprise a request to drive an elevator car 114a-114n to a destination landing. The elevator car calls are not allocated as the elevator car call must be served by the elevator car 114a-114n from where the elevator car call is generated. However, the currently existing elevator car calls are taken into account in the allocation of other elevator calls. Therefore, the obtained call information may comprise also indication of at least one generated elevator car call. The landing call may comprise a request to drive an elevator car 114a-114n to a landing from which the elevator call is generated. The destination call may comprise a request to drive an elevator car 114a-114n from a landing from which the elevator call is generated to a destination landing.

At a step 420, the elevator computing system 120, 130 generates a plurality of candidate allocations in response to obtaining the call information. Each generated candidate allocation of the plurality of candidate allocations comprises one or more possible candidate routes for one or more available elevator cars 114a-114n of the elevator group 110. A single candidate allocation belonging to the plurality of candidate allocations may comprise allocations of all currently existing elevator calls indicated in the obtained call information. The single candidate allocation may imply one or more candidate routes for each of the one or more available elevator cars 114a-114n. A single candidate route for one elevator car 114a-114n may comprise a plurality of movement cycles. As discussed above, one movement cycle of one elevator car 114a-114n corresponds to a movement of the elevator car 114a-114n from a floor to another floor. In addition to the plurality of candidate allocations generated in response to the receiving the call information, there may already exist one or more previously generated candidate allocations that may be included in the candidate allocations in the following steps of the elevator call allocation process. Next a non-limiting example of generating one candidate allocation is discussed, where the elevator group 110 comprises two available elevator cars, e.g. a first elevator car 114a and a second elevator car 114b. The first elevator car 114a may be vacant at a floor 0, the second elevator car 114b may be at a floor 3 picking up one or more passengers travelling to floor 5. The obtained call information may comprise indication of two new destination calls to be allocated, e.g. a first destination call from a floor 6 to a floor 7 and a second destination call from a floor 8 to a floor 9. The generated example candidate allocation may comprise an allocation of the first destination call for the first elevator car 114a and an allocation of the second destination call for the second elevator car 114b. The candidate routes for this example candidate allocation may comprise the following: the first elevator car 114a travelling from the floor 0 to the floor 6 and from the floor 6 to the floor 8 causing two movement cycles; and the second elevator car 114b travelling from the floor 3 to the floor 5, from the floor 5 to the floor 8, and from the floor 8 to the floor 9 causing three movement cycles. With the term “available elevator car 114a-114n” is meant throughout this application an elevator car 114a-114n of the elevator group 110 being capable to serve the at least one elevator call indicated in the obtained call information. For example, there may exists situations, where one or more floors are not served by all elevator cars 114a-114n of the elevator group 110.

At a step 430, the elevator computing system 120, 130 defines at least two allocation objectives for each candidate allocation. The defined at least two allocation objectives comprise a rope bending cost defined for each candidate allocation and at least one other allocation objective defined for each candidate allocation. In other words, at the step 430 the elevator computing system 120, 130 defines the rope bending cost for each candidate allocation, that is one allocation objective belonging to the at least two allocation objectives, and at least one other allocation objective for each candidate allocation belonging to the at least two allocation objectives. The at least one other allocation objective may comprise for example waiting time data, journey time data, energy consumption data, and/or power peak data. The rope bending cost may comprise a summary statistic or a list of summary statistics (i.e. a (real) number or a finite-dimensional vector of (real) numbers) summarizing how harmful a potential set of bendings caused by each candidate allocation would be for one or more involved elevator ropes 115. A higher rope bending cost corresponds to more harmful wear caused to the elevator rope 115. For example, a number of bendings caused to a rope segment of a first elevator rope would produce a lower rope bending cost than the same number of bendings caused to a rope segment of a second elevator rope being in worse condition than the first elevator rope. According to another example, a number of bendings caused to a first rope segment of an elevator rope would produce a lower rope bending cost than the same number of bendings caused to a second rope segment of the same elevator rope being in worse condition than the first segment.

FIG. 4B schematically discloses part of the flow chart of FIG. 4A in more detailed manner. Especially the step 430 becomes clear from FIG. 4B. As discussed above, the defining the at least two allocation objectives at the step 430 may comprise defining the rope bending cost for each candidate allocation (steps 432 to 436) and defining the at least one other allocation objective for each candidate allocation (step 438). In FIG. 4B the rope bending costs are defined before the defining of the at least one other allocation objective, but the at least one other allocation objective may alternatively be defined before defining the rope bending costs. The defining the rope bending costs of each candidate allocation may comprise the following steps: defining current condition data of each rope segment 202a-202n involved in said candidate allocation at the step 432, defining condition change data of each rope segment 202a-202n involved in said candidate allocation at the step 434, and defining, e.g. computing, the rope bending cost based on the defined current condition data and condition change data of each rope segment involved in said candidate allocation at the step 436. The current condition data represents the current condition of said segment 202a-202n. The condition change data represents the estimated condition of said segment 202a-202n after said candidate allocation, i.e. an estimation how the condition of said segment 202a-202n would change if the candidate allocation would occur.

According to one embodiment, the condition change data of each rope segment 202a-202n involved in said candidate allocation may be defined at the step 434 by counting an estimation of bendings of each rope segment 202a-202n involved in said candidate allocation. In other words, the condition change data of each rope segment 202a-202n involved in said candidate allocation may be defined by counting the estimation of bendings of each rope segment 202a-202n of each elevator rope 115 of the elevator group 110 that said candidate allocation would cause. For example, if an example candidate allocation would cause bendings to rope segments 202a-202n of one elevator rope 115 of the elevator group 110, the estimation of bendings of each rope segment 202a-202n of said one elevator rope 115 may be counted. According to another example, if an example candidate allocation would cause bendings to rope segments 202a-202n of two elevator ropes 115 of the elevator group 110, the estimation of bendings of each rope segment 202a-202n of each of said two elevator ropes 115 may be counted. When the condition change data is defined at the step 434 by counting the estimation of bendings of each rope segment 202a-202n involved in said candidate allocation, i.e. the condition change data comprises the counted estimation of bendings, the current condition data of each rope segment 202a-202n used for the defining the rope bending cost at the step 436 may comprise current rope bending count of said rope segment 202a-202n and/or current rope condition count of said rope segment 202a-202n. The current rope bending count of each rope segment 202a-202n may be defined at the step 432 by the elevator computing system 120, 130 as described above referring to the defining and maintaining the rope bending count of the rope segments 202a-202n. The current rope condition count of said rope segment 202a-202n may be defined at the step 432 by the elevator computing system 120, 130 as described above referring to the defining and maintaining the rope condition count of the rope segments 202a-202n by using the predefined mapping. In other words, the current rope bending count of the rope segment 202a-202n may indicate a number of currently, i.e. so far, counted bendings of said rope segment 202a-202n, i.e. the rope bending count of said rope segment 202a-202n at that moment maintained by the elevator group control unit 120 and/or the external computing unit 130 as discussed above. The current rope condition count of the rope segment 202a-202n may indicate numerically the current condition of said rope segment 202a-202n, i.e. the rope condition count of said rope segment 202a-202n at that moment maintained by the elevator group control unit 120 and/or the external computing unit 130 as discussed above. Alternatively, when the condition change data is defined at the step 434 by counting the estimation of bendings of each rope segment 202a-202n involved in said candidate allocation, the current rope data of each rope segment 202a-202n may comprise the sensor-based rope condition count of each rope segment 202a-202n defined by using the actual condition data as discussed above.

Alternatively according to another embodiment, the condition change data of each rope segment 202a-202n involved in said candidate allocation may be defined at the step 434 by providing, e.g. generating, an estimation of a changed condition 504 of each rope segment 202a-202n involved in said candidate allocation by applying the rope condition model 302. A term “modelled condition change data” is used throughout this application to mean the estimation of changed condition 504 defined by using the rope condition model 302. Above it is defined that the rope condition model 302 may be used to define the modelled rope condition count, but the rope condition model 302 may alternatively or in addition be used to define the modelled condition change data 504 of each rope segment 202a-202n involved in said candidate allocation. When the condition change data is defined at the step 434 by applying the rope condition model 302, i.e. when the condition change data comprises the modelled condition change data 504 (i.e. the provided estimation of the changed condition), the current condition data of each rope segment 202a-202n used for defining the rope bending cost at the step 438 may comprise the modelled rope condition count 306 of each rope segment 202a-202n defined by the rope condition module 302 as discussed above. In other words, at the step 432 the defining the current condition data comprises defining the modelled rope condition count 306 as discussed above, when the condition change data is defined at the step 434 by applying the rope condition model 302. Alternatively, when the condition change data is defined at the step 434 by applying the rope condition model 302, the current rope data of each rope segment 202a-202n may comprise the sensor-based rope condition count of each rope segment 202a-202n defined by using the actual condition data as discussed above. Next the operation of the rope condition model 302 is discussed referring to FIG. 5, which illustrates schematically an example of the definition of the modelled condition change data 504 by using the rope condition model 302. The modelled condition change data 504 for each rope segment 202a-202n of each elevator rope 115 of the elevator group 110 involved in said candidate allocation may be defined by using the rope condition model 302. The defining the modelled condition change data 504 by using the rope condition model 302 may comprise using the previously modelled rope condition count 306 (i.e. the modelled rope condition count before the movement cycles of the candidate allocation) or the sensor-based rope condition count 306 and movement data of the movement cycles of the candidate allocation 502 as inputs for the rope condition model 302 to provide the modelled condition change data 504 as the output of the rope condition model 302. The movement data of the movement cycles of the candidate allocation 502 may comprise starting times (i.e. timestamp) of the movement cycles, elevator identifiers (ID) identifying the elevator cars 114a-114n, origin landings of the movement cycles, destination landings of the movement cycles, load data of the elevator cars 114a-114n, and/or one or more other movement factors. In other words, the elevator computing system 120, 130 is able to infer or estimate by using the rope condition model 302 from the input data, the output data (i.e. the modelled condition change data 504) representing an estimation how the candidate allocation impacts on the rope segments involved in said candidate allocation, i.e. what is estimated to happen to the modelled rope condition counts of the rope segments due to the candidate allocation.

Causing further bendings to the rope segments 202a-202n for which the current rope data indicates higher current rope bending count is more costly, i.e. causes higher rope bending cost, than causing further bendings to the rope segments 202a-202n for which the current rope data indicates lower current rope bending count. According to an example, if the current rope bending count of a first segment of an elevator rope is ten and the current rope bending count of a second segment of the same elevator rope is five, causing further bendings to the first segment of the elevator rope causes higher rope bending cost than causing further bendings to the second segment of the same elevator rope. According to another example, if the current rope bending count of a segment of a first elevator rope is fifteen and the current rope bending count of a segment of a second elevator rope is four, causing further bendings to the segment of the first elevator rope causes higher rope bending cost than causing further bendings to the segment of the second elevator rope. According to another example, if the current rope bending count of a segment of an elevator rope of a first elevator is 2 out of 10 and the current rope bending count of a segment of an elevator rope of a second elevator is 8 out of 10 (wherein 10 is the maximum number, i.e. totally worn rope), the segment of the elevator rope of the first elevator would ⅛ remaining rope bendings, i.e. 12.5% of the remaining resource, and the segment of the elevator rope of the second elevator would utilize ½, i.e. 50% of the remaining resource. Thus, causing further bendings to the segment of the elevator rope of the second elevator is more costly, i.e. causes higher rope bending cost, than causing further bendings to the segment of the elevator rope of the first elevator. In other words, using a greater amount of the remaining resource is more costly. According to yet another example, if one candidate route passes multiple rope segments 202a-202n each having different rope bending counts, the overall rope bending count for said one candidate route may be defined for example based on the rope bending count of the rope segment(s) 202a-202n having the highest rope bending count, the average of the rope bending counts of the multiple rope segments 202a-202n, or the weighted average of the rope bending counts of the multiple rope segments 202a-202n. Similarly, causing further bendings to the rope segments 202a-202n for which the current rope data indicates lower/smaller current rope condition count is more costly, i.e. causes higher rope bending cost, than causing further bendings to the rope segments 202a-202n for which the current rope data indicates higher/larger current rope condition count. According to an example, if the current rope condition count of a first segment of an elevator rope is 40% and the current rope condition count of a second segment of the same elevator rope is 80%, causing further bendings to the first segment of the elevator rope causes higher rope bending cost than causing further bendings to the second segment of the same elevator rope. According to an example, if the current rope condition count is expressed as the rope diameter data, causing further bendings to the rope segments 202a-202n for which the current rope data indicates smaller diameter is more costly, i.e. causes higher rope bending cost, than causing further bendings to the rope segments 202a-202n for which the current rope data indicates larger diameter.

At a step 440, the elevator computing system 120, 130 selects the allocation, i.e. the actual allocation that will be realized, for the at least one elevator call from among the candidate allocations based on at least two allocation objectives defined at the step 430. As discussed above the at least two allocation objectives, based on which the allocation is selected at the step 440, comprise the rope bending cost defined for each candidate allocations and the defined at least one other allocation objective defined for each candidate allocations. Selecting the allocation for the elevator call at the step 340 may be performed by using a multi-objective optimization framework. An example of the multi-objective optimization framework is disclosed in a patent publication EP 1 368 267 B1. For example, the candidate allocation having lower rope bending cost than one or more other candidate allocations may be selected as the allocation to be realized. By using the rope bending cost defined for each candidate allocations as the one allocation objective for the selection allocation for the at least one elevator call in addition to at least one other allocation objective, enables that the wear of the elevator ropes 115 of the elevator group 110 are taken into account in the allocation of the at least one elevator call of the elevator group 110. Moreover, this enables that the number of rope bendings may be balanced between rope segments 202a-202n of a single elevator rope 115 and also between the elevator ropes 115 of the elevator group 110 and thereby enables increasing the lifetime of the elevator ropes 115. If the selection at the step 440 is performed by the external computing unit 130, the external computing unit 130 may provide an indication of the selected allocation for the at least one elevator call to the elevator group control unit 120 for realizing the selected allocation.

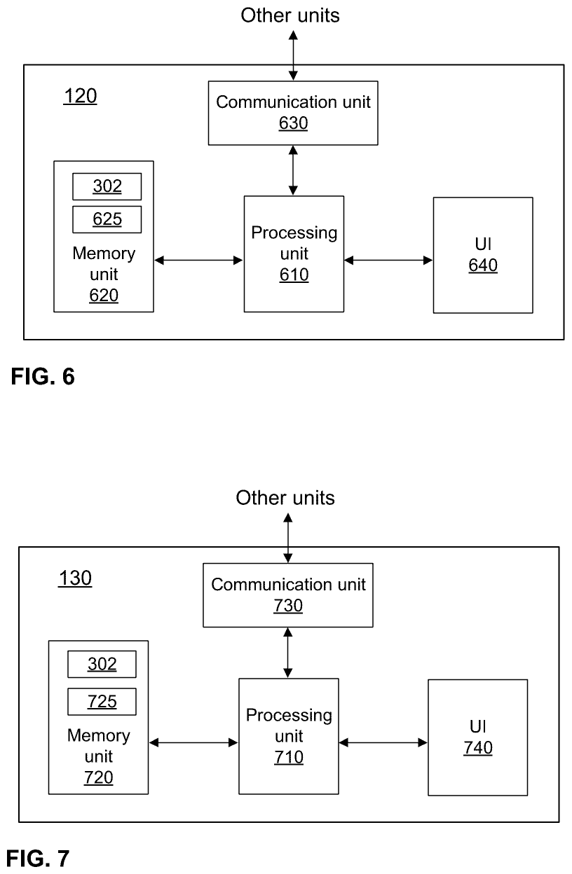

FIG. 6 illustrates schematically an example of components of the elevator group control unit 120. The elevator group control unit 120 may comprise a processing unit 610 comprising one or more processors, a memory unit 620 comprising one or more memories, a communication interface unit 630 comprising one or more communication devices, and possibly a user interface (UI) unit 640. The mentioned elements may be communicatively coupled to each other with e.g. an internal bus. The memory unit 620 may store and maintain portions of a computer program (code) 625, the rope condition model 302, the rope bending count, the rope condition count, and any other data. The computer program 625 may comprise instructions which, when the computer program 625 is executed by the processing unit 610 of the elevator group control unit 120 may cause the processing unit 610, and thus the elevator group control unit 120 to carry out desired tasks, e.g. one or more of the method steps described above and/or the operations of the elevator group control unit 120 described above. The processing unit 610 may thus be arranged to access the memory unit 620 and retrieve and store any information therefrom and thereto. For sake of clarity, the processor herein refers to any unit suitable for processing information and control the operation of the elevator group control unit 120, among other tasks. The operations may also be implemented with a microcontroller solution with embedded software. Similarly, the memory unit 620 is not limited to a certain type of memory only, but any memory type suitable for storing the described pieces of information may be applied in the context of the present invention. The communication interface unit 630 provides one or more communication interfaces for communication with any other unit, e.g. the external computing unit 130, the elevator control units 118a-118n of the elevators 112a-112n, the at least one rope condition monitoring sensor device, one or more databases, or with any other unit. The user interface unit 640 may comprise one or more input/output (I/O) devices, such as buttons, keyboard, touch screen, microphone, loudspeaker, display and so on, for receiving user input and outputting information. The computer program 625 may be a computer program product that may be comprised in a tangible nonvolatile (non-transitory) computer-readable medium bearing the computer program code 625 embodied therein for use with a computer, i.e. the elevator group control unit 120.

FIG. 7 illustrates schematically an example of components of the external computing unit 130. The external computing unit 130 may comprise a processing unit 710 comprising one or more processors, a memory unit 720 comprising one or more memories, a communication interface unit 730 comprising one or more communication devices, and possibly a user interface (UI) unit 740. The mentioned elements may be communicatively coupled to each other with e.g. an internal bus. The memory unit 720 may store and maintain portions of a computer program (code) 725, the rope condition model 302, the rope bending count, the rope condition count, and any other data. The computer program 725 may comprise instructions which, when the computer program 725 is executed by the processing unit 710 of the external computing unit 130 may cause the processing unit 710, and thus the external computing unit 130 to carry out desired tasks, e.g. one or more of the method steps described above and/or the operations of the external computing unit 130 described above. The processing unit 710 may thus be arranged to access the memory unit 720 and retrieve and store any information therefrom and thereto. For sake of clarity, the processor herein refers to any unit suitable for processing information and control the operation of the external computing unit 130, among other tasks. The operations may also be implemented with a microcontroller solution with embedded software. Similarly, the memory unit 720 is not limited to a certain type of memory only, but any memory type suitable for storing the described pieces of information may be applied in the context of the present invention. The communication interface unit 730 provides one or more communication interfaces for communication with any other unit, e.g. the elevator group control unit 120, one or more databases, or with any other unit. The user interface unit 740 may comprise one or more input/output (I/O) devices, such as buttons, keyboard, touch screen, microphone, loudspeaker, display and so on, for receiving user input and outputting information. The computer program 725 may be a computer program product that may be comprised in a tangible nonvolatile (non-transitory) computer-readable medium bearing the computer program code 725 embodied therein for use with a computer, i.e. the external computing unit 130.

The method and the elevator computing system 120, 130 discussed above enable increasing elevator rope lifetime by balancing in the elevator call allocation rope wear both between different elevator ropes and within a single elevator rope, thus minimizing resource consumption and unnecessary maintenance visits. The method and the elevator computing system 120, 130 discussed above enable to take into account which parts (i.e. rope segments) of the elevator rope would get wear in the candidate routes, thereby making better decisions as not all distance traveled by the elevator car is equal in terms of elevator rope wear. Furthermore, the embodiments utilizing the rope condition monitoring sensor devices improve the elevator call allocation and the correspondence with the reality. Similarly, the embodiments utilizing the rope condition model improve the elevator call allocation and the correspondence with the reality.

The specific examples provided in the description given above should not be construed as limiting the applicability and/or the interpretation of the appended claims. Lists and groups of examples provided in the description given above are not exhaustive unless otherwise explicitly stated.

1. A method for an elevator call allocation of an elevator group, wherein the method comprises the steps of:
obtaining call information indicative of at least one generated elevator call; generating a plurality of candidate allocations in response to obtaining the call information;
defining at least two allocation objectives for each candidate allocation, wherein the defined at least two allocation objectives comprise a rope bending cost and at least one other allocation objective; and
selecting the allocation for the at least one elevator call from among the candidate allocations based on the defined at least two allocation objectives.

2. The method according to claim 1, wherein each elevator rope of the elevator group is divided into a plurality of rope segments, and wherein defining the rope bending cost for each candidate allocation comprises:
defining current condition data of each rope segment involved in said candidate allocation;
defining condition change data of each rope segment involved in said candidate allocation; and
defining the rope bending cost based on the defined current condition data and condition change data of each rope segment involved in said candidate allocation.

3. The method according to claim 2, wherein the defining the condition change data comprises counting an estimation of bendings of each rope segment involved in said candidate allocation.

4. The method according to claim 3, wherein the current condition data of each rope segment comprises:
a rope bending count of said rope segment indicating currently counted bendings of said rope segment; or
a rope condition count of said rope segment indicating current condition of said rope segment defined by pre-estimated mapping between the rope condition count and the rope bending count of said rope segment.

5. The method according to claim 2, wherein the defining the condition change data comprises providing an estimation of a changed condition of each rope segment involved in said candidate allocation by applying a rope condition model.

6. The method according to claim 5, wherein the current condition data of each rope segment comprises a modelled rope condition count of said rope segment defined by applying the rope condition model.

7. The method according to claim 3, wherein the current condition data of each segment comprises a sensor-based rope condition count of said rope segment defined by using actual condition data representing the actual condition of said rope segment.

8. The method according to claim 7, wherein the actual condition data is obtained by at least one rope condition monitoring sensor device arranged inside a respective elevator shaft of the elevator group and/or by a rope condition monitoring sensor device operated by a user during a maintenance visit.

9. The method according to claim 8, wherein the at least one rope condition monitoring sensor device is a rope diameter monitoring device, and the rope condition count comprises rope diameter data representing a diameter of the rope segment.

10. An elevator computing system for an elevator call allocation of an elevator group, the elevator computing system comprising:
a processing unit comprising at least one processor; and
a memory unit comprising at least one memory including computer program code,
wherein the at least one memory and the computer program code are configured to, with the at least one processor, cause the elevator computing system to:
obtain call information indicative of at least one generated elevator call;
generate a plurality of candidate allocations in response to obtaining the call information;
define at least two allocation objectives for each candidate allocation, wherein the defined at least two allocation objectives a rope bending cost and at least one other allocation objective; and
select the allocation for the at least one elevator call from among the candidate allocations based on defined at least two allocation objectives.

11. The elevator computing system according to claim 10, wherein each elevator rope of the elevator group is divided into a plurality of rope segments, and wherein the defining of the rope bending cost for each candidate allocation comprises that the elevator computing system is configured to:
define current condition data of each rope segment involved in said candidate allocation;
define condition change data of each rope segment involved in said candidate allocation; and
define the rope bending cost based on the defined current condition data and condition change data of each rope segment involved in said candidate allocation.

12. The elevator computing system according to claim 11, wherein the defining of the condition change data comprises that the elevator computing system is configured to count an estimation of bendings of each rope segment involved in said candidate allocation.

13. The elevator computing system according to claim 12, wherein the current condition data of each rope segment comprises:
a rope bending count of said rope segment indicating currently counted bendings of said rope segment; or
a rope condition count of said rope segment indicating current condition of said rope segment defined by pre-estimated mapping between the rope condition count and the rope bending count of said rope segment.

14. The elevator computing system according to claim 11, wherein the defining of the condition change data comprises that the elevator computing system is configured to provide an estimation of a changed condition of each rope segment involved in said candidate allocation by applying a rope condition model.

15. The elevator computing system according to claim 14, wherein the current condition data of each rope segment comprises a modelled rope condition count of said rope segment defined by applying the rope condition model.

16. The elevator computing system according to claim 12, wherein the current condition data of each segment comprises a sensor-based rope condition count of said rope segment defined by using actual condition data representing the actual condition of said rope segment.

17. The elevator computing system according to claim 16, wherein the actual condition data is obtained by at least one rope condition monitoring sensor device arranged inside a respective elevator shaft of the elevator group and/or by a rope condition monitoring sensor device operated by a user during a maintenance visit.

18. The elevator computing system according to claim 17, wherein the at least one rope condition monitoring sensor device is a rope diameter monitoring device, and the rope condition count comprises rope diameter data representing a diameter of the rope segment.

19. A computer program product for an elevator call allocation of an elevator group, the computer program product being embodied on a non-transitory computer readable medium, and when executed by at least one processor, causes an elevator computing system to perform the method according to claim 1.

20. The method according to claim 5, wherein the current condition data of each segment comprises a sensor-based rope condition count of said rope segment defined by using actual condition data representing the actual condition of said rope segment.
